(19) United States
(12) Patent Application Publication
(10) Pub. No.: US 2023/0000243 A1
(43) Pub. Date: Jan. 5, 2023

(54) DENTAL CLEANING DEVICE

(71) Applicant: Charles Mccloud, Fort Lee, NJ (US)

(72) Inventor: Charles Mccloud, Fort Lee, NJ (US)

(21) Appl. No.: 17/830,680

(22) Filed: Jun. 2, 2022

Related U.S. Application Data
(60) Provisional application No. 63/218,479, filed on Jul. 5, 2021.

(51) Int. Cl. A46B 15/00; A61C 15/04; A46B 17/06

(52) U.S. Cl. CPC A46B 15/0071; A61C 15/043; A46B 15/0081; A46B 17/065; A46B 2200/1066

(57) ABSTRACT

A dental cleaning device, including a main body to facilitate gripping thereof, a plurality of bristles disposed on at least a portion of a first end of the main body to facilitate brushing of at least one tooth, and a floss compartment disposed within at least a portion of a second end of the main body, the floss compartment including a floss roll to coil a line of floss, a floss dispensing aperture connected to the floss roll to receive the line of floss therethrough from the floss roll, and a blade disposed around the floss dispensing aperture to cut the line of floss.

### CROSS-REFERENCE TO RELATED APPLICATIONS

This application claims priority under 35 USC § 120 from U.S. Provisional Application No. 63/218,479, entitled “Dental Cleaning Device,” which was filed on Jul. 5, 2021, in the United States Patent and Trademark Office, the disclosure of which is incorporated herein in its entirety by reference.

### BACKGROUND

### 1. Field

The present general inventive concept relates generally to dental cleaning, and particularly, to a dental cleaning device.

### 2. Description of the Related Art

Proper dental hygiene is important part of a daily regimen. Most people brush their teeth at least once a day. Unfortunately, many people forget and/or overlook flossing as part of their teeth cleaning. Flossing is an equally important activity to maintain proper oral health.

Part of the problem in people overlooking flossing is the need to purchase a separate accessory. Specifically, a floss dispenser is typically required to obtain and/or use floss. The floss dispenser is easily lost and/or misplaced.

Therefore, there is a need for a dental cleaning device that combines a brush with a floss dispenser that serves as a reminder for a user to floss.

### SUMMARY

The present general inventive concept provides a dental cleaning device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a dental cleaning device, including a main body to facilitate gripping thereof, a plurality of bristles disposed on at least a portion of a first end of the main body to facilitate brushing of at least one tooth, and a floss compartment disposed within at least a portion of a second end of the main body, the floss compartment including a floss roll to coil a line of floss, a floss dispensing aperture connected to the floss roll to receive the line of floss therethrough from the floss roll, and a blade disposed around the floss dispensing aperture to cut the line of floss.

The dental cleaning device may further include a cap hingedly disposed on at least a portion of the second end of the main body to move from closed in a first position to at least partially opened in a second position, and move from opened in the second position to closed in the first position.

The dental cleaning device may further include a tongue scraper disposed on at least a portion of the first end of the main body to facilitate cleaning of a tongue.

The tongue scraper may extend away from the main body in a direction opposite to the plurality of bristles.

The dental cleaning device may further include a sanitization unit disposed within at least a portion of the first end of the main body to sanitize the plurality of bristles in response to being turned on.

The sanitization unit may dispense a cleansing liquid toward the plurality of bristles.

The sanitization unit may emit an ultraviolet (UV) light toward the plurality of bristles.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a dental cleaning device, according to an exemplary embodiment of the present general inventive concept;

FIG. 2 illustrates a zoomed in view of a floss compartment, according to an exemplary embodiment of the present general inventive concept; and

FIG. 3 illustrates a zoomed in view of a tongue scraper, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Dental Cleaning Device 100

Main Body 110

Neck 111

Head 112

Bristles 120

Floss Compartment 130

Floss Roll 131

Floss Dispensing Aperture 132

Blade 133

Cap 140

Tongue Scraper 150

Motor 160

Power Button 170

Sanitization Unit 180

Power Source 190

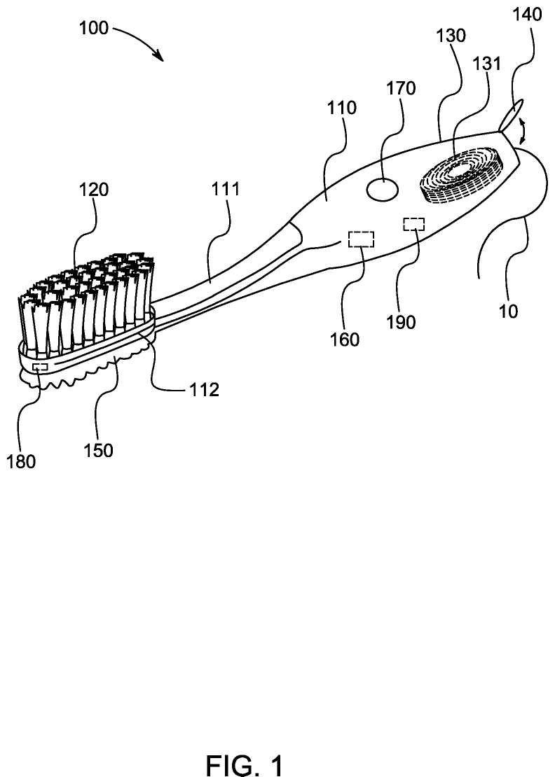

FIG. 1 illustrates a side perspective view of a dental cleaning device 100, according to an exemplary embodiment of the present general inventive concept.

The dental cleaning device 100 may be constructed from at least one of metal, plastic, wood, glass, ceramic, and rubber, etc., but is not limited thereto.

The dental cleaning device 100 may include a main body 110, a plurality of bristles 120, a floss compartment 130, a cap 140, a tongue scraper 150, a motor 160, a power button 170, a sanitization unit 180, and a power source 190, but is not limited thereto.

The main body 110 may include a neck 111 and a head 112, but is not limited thereto.

The main body 110 may operate as a handle. In other words, the main body 110 may facilitate gripping thereof.

The neck 111 may be disposed on at least a portion of a first end of the main body 110. Moreover, the neck 111 may have a size and/or a shape different than a remainder of the main body 110. For example, the size and/or the shape of the neck 111 may be smaller than a size and/or a shape of the main body 110. Also, the neck 111 may be more narrow and/or elongate with respect to the remainder of the main body 110, such that the neck 111 may be at least partially inserted into a mouth of a user.

The head 112 may be disposed on at least a portion of the first end of the main body 110. Also, the head 112 may be disposed at an end of the neck 111.

The plurality of bristles 120 may be constructed to be soft bristles, hard bristles, and/or any combination thereof, but is not limited thereto. More specifically, hard bristles may be more rigid compared to soft bristles. In other words, soft bristles may at least partially deform (i.e. bend, flex) in response to contact with at least one tooth. As such, the soft bristles may prevent abrasion to the at least one tooth and gums.

The plurality of bristles 120 may be disposed on at least a portion of the first end of the main body 110. Also, the plurality of bristles 120 may be perpendicularly disposed away from a surface of a first side of the head 112 with respect to a first direction. As such, the plurality of bristles 120 may brush the at least one tooth while at least partially inserted into the mouth of the user.

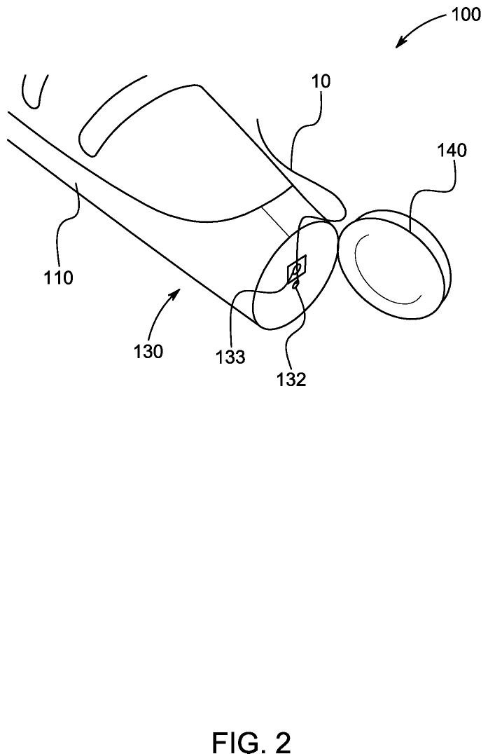

FIG. 2 illustrates a zoomed in view of a floss compartment 130, according to an exemplary embodiment of the present general inventive concept.

The floss compartment 130 may include a floss roll 131, a floss dispensing aperture 132, and a blade 133, but is not limited thereto.

The floss compartment 130 may be disposed on and/or within at least a portion of a second end of the main body 110. Additionally, the floss roll 131 may be disposed within the floss compartment 130, such that a line of floss 10 is coiled within the floss compartment 130. Furthermore, the floss roll 131 may rotate in response to the line of floss 10 being extracted from the floss compartment 130.

The floss dispensing aperture 132 may be disposed on at least a portion of the second end of the main body 110. The floss dispensing aperture 132 may receive the line of floss 10 therethrough and/or facilitate extraction of the line of floss 10 from within the floss compartment 130.

The blade 133 may be disposed on at least a portion of the second end of the main body 110. The blade 133 may cut the line of floss 10. As such, the blade 133 may separate the line of floss 10 from the floss roll 131, such that the line of floss 10 may be used by the user to extract at least one particle of food disposed between the teeth.

The cap 140 may be hingedly disposed on at least a portion of the second end of the main body 110. The cap 140 may move from closed in a first position to at least partially opened in a second position, and from open in the second position to closed in the first position. In other words, the cap 140 may close over the floss dispensing aperture 132 and/or the blade 133 in the first position and open to facilitate access to the line of floss 10 in the second position. As such, the cap 140 may prevent access to the line of floss 10 while closed.

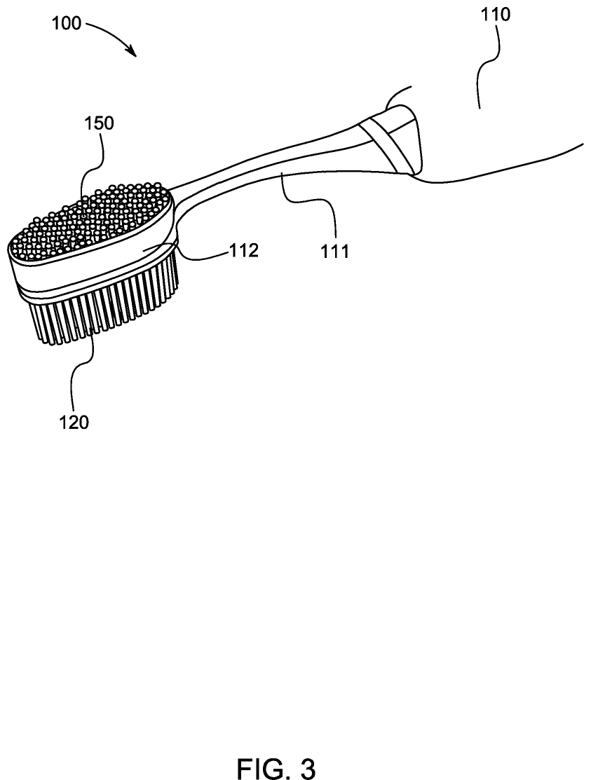

FIG. 3 illustrates a zoomed in view of a tongue scraper 150, according to an exemplary embodiment of the present general inventive concept.

The tongue scraper 150 may include a plurality of bulbous protrusions. Also, the tongue scraper 150 may be soft and/or hard. More specifically, the tongue scraper 150 being hard may be more rigid compared to being soft. In other words, the tongue scraper 150 being soft may at least partially deform (i.e. bend, flex) in response to contact with a tongue of the user.

The tongue scraper 150 may be disposed on at least a portion of the first end of the main body 110. More specifically, the tongue scraper 150 may be perpendicularly disposed away from a surface of a second side of the head 112 with respect to a second direction opposite with respect to the first direction. Also, the second side of the head 112 may be disposed opposite with respect to the first side of the head 112. Accordingly, the tongue scraper 150 may be disposed opposite with respect to the plurality of bristles 120. Therefore, the tongue scraper 150 may facilitate cleaning of the tongue of the user in response to contact with the tongue by extracting at least one particle of food from the tongue.

The motor 160 may be disposed within at least a portion of the main body 110 and/or connected to the plurality of bristles 120. The plurality of bristles 120 may vibrate in response to movement of the motor 160. The plurality of bristles 120 may loosen at least one particle of food on the at least one tooth in response to vibrating.

The power button 170 may be disposed on at least a portion of the main body 110. The power button 170 may turn on the motor 160 in response to being depressed a first time, and turn off the motor 160 in response to being depressed a second time.

The sanitization unit 180 may include a cleansing liquid (e.g., soap) and an ultraviolet (UV) light, but is not limited thereto.

The sanitization unit 180 may be disposed on and/or within at least a portion of the head 112. Moreover, the sanitization unit 180 may dispense the cleansing liquid and/or emit the UV light toward the plurality of bristles 120 in response to depressing the power button 170 for a predetermined duration of time (e.g., five seconds). As such, the sanitization unit 180 may clean and/or sanitize the plurality of bristles 120. Also, the sanitization unit 180 may automatically turn off after a predetermined time period (e.g., one minute).

The power source 190 may include a battery and a solar cell, but is not limited thereto.

The power source 190 may be disposed on and/or within at least a portion of the main body 110. The power source 190 may send power to the motor 160, the power button 170, and/or the sanitization unit 180.

Therefore, the dental cleaning device 100 may provide an all-in-one solution for maintaining oral health. The dental cleaning device 100 may allow teeth to be cleaned through brushing as well as conveniently providing the line of floss 10 for additional cleaning.

The present general inventive concept may include a dental cleaning device 100, including a main body 110 to facilitate gripping thereof, a plurality of bristles 120 disposed on at least a portion of a first end of the main body 110 to facilitate brushing of at least one tooth, and a floss compartment 130 disposed within at least a portion of a second end of the main body 110, the floss compartment 130 including a floss roll 131 to coil a line of floss 10, a floss dispensing aperture 132 connected to the floss roll 131 to receive the line of floss 10 therethrough from the floss roll 131, and a blade 133 disposed around the floss dispensing aperture 132 to cut the line of floss 10.

The dental cleaning device 100 may further include a cap 140 hingedly disposed on at least a portion of the second end of the main body 110 to move from closed in a first position to at least partially opened in a second position, and move from opened in the second position to closed in the first position.

The dental cleaning device 100 may further include a tongue scraper 150 disposed on at least a portion of the first end of the main body 110 to facilitate cleaning of a tongue.

The tongue scraper 150 may extend away from the main body 110 in a direction opposite to the plurality of bristles 120.

The dental cleaning device 100 may further include a sanitization unit 180 disposed within at least a portion of the first end of the main body 110 to sanitize the plurality of bristles 120 in response to being turned on.

The sanitization unit 180 may dispense a cleansing liquid toward the plurality of bristles 120.

The sanitization unit 180 may emit an ultraviolet (UV) light toward the plurality of bristles 120.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A dental cleaning device, comprising:
a main body to facilitate gripping thereof;
a plurality of bristles disposed on at least a portion of a first end of the main body to facilitate brushing of at least one tooth; and
a floss compartment disposed within at least a portion of a second end of the main body, the floss compartment comprising:
a floss roll to coil a line of floss,
a floss dispensing aperture connected to the floss roll to receive the line of floss therethrough from the floss roll, and
a blade disposed around the floss dispensing aperture to cut the line of floss.

2. The dental cleaning device of claim 1, further comprising:
a cap hingedly disposed on at least a portion of the second end of the main body to move from closed in a first position to at least partially opened in a second position, and move from opened in the second position to closed in the first position.

3. The dental cleaning device of claim 1, further comprising:
a tongue scraper disposed on at least a portion of the first end of the main body to facilitate cleaning of a tongue.

4. The dental cleaning device of claim 3, wherein the tongue scraper extends away from the main body in a direction opposite to the plurality of bristles.

5. The dental cleaning device of claim 1, further comprising:
a sanitization unit disposed within at least a portion of the first end of the main body to sanitize the plurality of bristles in response to being turned on.

6. The dental cleaning device of claim 5, wherein the sanitization unit dispenses a cleansing liquid toward the plurality of bristles.

7. The dental cleaning device of claim 5, wherein the sanitization unit emits an ultraviolet (UV) light toward the plurality of bristles.
